(19) United States
(12) Patent Application Publication
(10) Pub. No.: US 2023/0387589 A1
(43) Pub. Date: Nov. 30, 2023

(54) SWITCHABLE ANTENNA ASSEMBLIES FOR OMNI-DIRECTIONAL 6E WIFI SIGNALING

(71) Applicant: KYOCERA AVX Components (San Diego), Inc., San Diego, CA (US)

(72) Inventors: Xiaoyan Yuan, San Diego, CA (US); Zhe Wang, San Diego, CA (US); Jesse Shihchieh Hsin, San Diego, CA (US)

(21) Appl. No.: 18/324,542

(22) Filed: May 26, 2023

Related U.S. Application Data
(60) Provisional application No. 63/347,316, filed on May 31, 2022.

(51) Int. Cl. H01Q 3/24; H01Q 19/10

(52) U.S. Cl. CPC H01Q 3/24; H01Q 19/108

(57) ABSTRACT

A switchable antenna assembly is provided. The switchable antenna assembly includes a substrate, a ground plane disposed on the substrate, and a feed. The switchable antenna assembly includes a first planar antenna element extending from the ground plane in a first direction. The first planar antenna element is coupled to the feed by a first transmission line and is configured to produce a first radiation pattern. The switchable antenna assembly includes a second planar antenna element extending from the ground plane in a second direction orthogonal to the first direction of first planar antenna element and is configured to produce a second radiation pattern. The switchable antenna assembly includes a single pole—two-throw switching element configured to selectively couple one of the first transmission line or the second transmission line to the feed.

### PRIORITY CLAIM

The present application is based on and claims priority to U.S. Provisional Application No. 63/347,316 titled “SWITCHABLE ANTENNA ASSEMBLIES FOR OMNI-DIRECTIONAL 6E WIFI SIGNALING,” having a filing date of May 31, 2022, which is incorporated by reference herein.

### FIELD

The present disclosure relates generally to a switching antenna assembly, and more particular to an antenna assembly with integrated switching between orthogonal planar antenna elements for omni-directional signaling.

### BACKGROUND

Antennas can be used to facilitate wireless communication between devices. Recent advances in telecommunications have enabled communications (e.g., WiFi signaling, etc.) at frequencies in a frequency band of, for instance, about 5 Ghz to about 7.2 Ghz. As such, antenna devices capable of efficiently communicating at such frequencies are greatly desired.

### SUMMARY

Aspects and advantages of embodiments of the present disclosure will be set forth in part in the following description, or may be learned from the description, or may be learned through practice of the embodiments.

One example aspect of the present disclosure is directed to a switchable antenna assembly. The switchable antenna assembly includes a substrate. The switchable antenna assembly includes a ground plane disposed on the substrate. The switchable antenna assembly includes a feed. The switchable antenna assembly includes a first planar antenna element extending from the ground plane in a first direction, wherein the first planar antenna element is coupled to the feed by a first transmission line, wherein the first planar antenna element is configured to produce a first radiation pattern. The switchable antenna assembly includes a second planar antenna element extending from the ground plane in a second direction orthogonal to the first direction of first planar antenna element, wherein the second planar antenna element is configured to produce a second radiation pattern. The switchable antenna assembly includes a single pole—two-throw switching element configured to selectively couple one of the first transmission line or the second transmission line to the feed.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1A illustrates a block diagram of an example switchable antenna assembly according to some embodiments of the present disclosure;

FIG. 1B depicts a side view of the switchable antenna assembly illustrated in FIG. 1A according to some embodiments of the present disclosure;

FIG. 2 is a block diagram for an example planar antenna element of FIG. 1A according to some embodiments of the present disclosure;

FIG. 3 illustrates a return loss plot associated with some example antenna assemblies according to some embodiments of the present disclosure;

FIG. 4 illustrates a radiation pattern of one of the antenna planar antenna elements of FIG. 1 according to some embodiments of the present disclosure;

FIG. 5 illustrates a schematic diagram of an embodiment of an antenna system in accordance with example aspects of the present disclosure; and

FIG. 6 is a flowchart illustrating an example method for omni-directional 6E Wifi signaling.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to WiFi signaling at certain frequency bands, such as frequency bands in a range of about 5 Ghz to about 7.2 Ghz. In some antenna applications, it can be useful to have multiple planar patch antenna elements for provision of omni-directional WiFi signaling using different radiation patterns.

For instance, in one example, it can be useful to provide a first patch antenna element configured to produce a first radiation pattern (e.g., associated with a first polarization) and a second patch antenna element configured to produce a second radiation pattern (e.g., associated with a second polarization) with both elements disposed on a substrate coupled to a ground plane. The first radiation pattern can be different from the second radiation pattern. In conjunction, data over coaxial (DOC) technology can be leveraged to provide both transmission data and a control signal that dynamically switches between the planar antenna elements for omni-directional provision of 6E WiFi signaling at multiple frequency bands.

According to example aspects of the present disclosure, a switchable antenna assembly can include a substrate (e.g., a circuit board), a ground plane disposed upon the substrate, and a feed. For example, a first surface of the substrate may contact a first surface of the ground plane, which is connected to a feed. The antenna assembly can include a first planar antenna element that extends from the ground plane in a first direction and a second planar antenna element that extends from the ground plane in a second direction. The first planar antenna element can be coupled to the substrate/ground plane by a first transmission line, and the second antenna element can be coupled to the substrate/ground plane by a second transmission line orthogonal to the first antenna element. The antenna assembly can include a single pole—two-throw switch element that's configured to selectively couple one of the first transmission line and/or the second transmission line to the feed. In such fashion, the first and second planar antenna elements can, in conjunction with a single pole two-throw switching element, collaboratively provide omni-directional 6E WiFi signaling.

In some embodiments, the first planar antenna element and the second planar antenna element are configured to produce a signal between about 5 GHz and about 7.2 GHz. As used herein, the use of the term “about” in conjunction with a numerical value refers to within 15% of the stated value.

In some embodiments, the two-throw switching element is controlled via a control circuit. In some embodiments, the switchable antenna assembly further comprises a data over coaxial circuit, and wherein the two-throw switching element is controlled via the control circuit based at least in part on a control signal carried over coaxial circuit (e.g., a control signal encoded into the data signal). In some embodiments, the control signal is modulated onto a radio frequency signal carried concurrently with the control signal via the data over coaxial circuit.

In some embodiments, the switchable antenna assembly further comprises a radio frequency circuit, and wherein the control signal is demodulated from the radio frequency signal using the radio frequency circuit.

In some embodiments, the radio frequency signal is defined within a first frequency band, and the control signal is defined within a second frequency band that is distinct from the first frequency band.

In some embodiments, the two-throw switching element is positioned atop the first and second transmission lines.

In some embodiments, the first radiation pattern is associated with a first polarization, the second radiation pattern is associated with a second polarization, the first polarization being different from the second polarization.

In some embodiments, the first planar antenna element defines a first shape, and wherein the second planar antenna element defines a second shape identical to the first shape.

In some embodiments, the first shape of the first planar antenna element comprises a straight first edge, a straight second edge parallel to the first edge, a straight third edge, wherein a first endpoint of the third edge contacts a first endpoint of the first edge and a second endpoint of the third edge contacts a first endpoint of the second edge, and a curved fourth edge, wherein a first endpoint of the fourth edge contacts a second endpoint of the first edge and a second endpoint of the fourth edge contacts a second endpoint of the second edge.

In some embodiments, the switchable antenna assembly is configured for 6e Wifi signaling.

Another example aspect of the present disclosure is directed to a method for signaling via a switchable antenna assembly. The method includes receiving, by a switchable antenna assembly, a signal over a data-over-coaxial circuit, wherein the switchable antenna assembly comprises a first planar antenna element connected to a feed via a first transmission line and an identically shaped second planar antenna element connected to the feed via a second transmission line. The method includes, based at least in part on the signal, controlling, by the switchable antenna assembly, a single pole—two-throw switching element to selectively couple one of the first transmission line or the second transmission line to the feed.

Another example aspect of the present disclosure is directed to a switchable antenna assembly. The switchable antenna assembly includes a substrate. The switchable antenna assembly includes a ground plane disposed on the substrate. The switchable antenna assembly includes a feed. The switchable antenna assembly includes a first planar antenna element extending from the substrate in a first direction. The first planar antenna element defines a first shape. The first shape includes a straight first edge. The first shape includes a straight second edge parallel to the first edge. The first shape includes a straight third edge, wherein a first endpoint of the third edge contacts a first endpoint of the first edge and a second endpoint of the third edge contacts a first endpoint of the second edge. The first shape includes a curved fourth edge, wherein a first endpoint of the fourth edge contacts a second endpoint of the first edge and a second endpoint of the fourth edge contacts a second endpoint of the second edge. The switchable antenna assembly includes a second planar antenna element extending from the substrate in a second direction orthogonal to the first direction, wherein the second planar antenna element defines a second shape identical to the first shape.

With reference now to the Figures, example embodiments of the present disclosure will now be set forth.

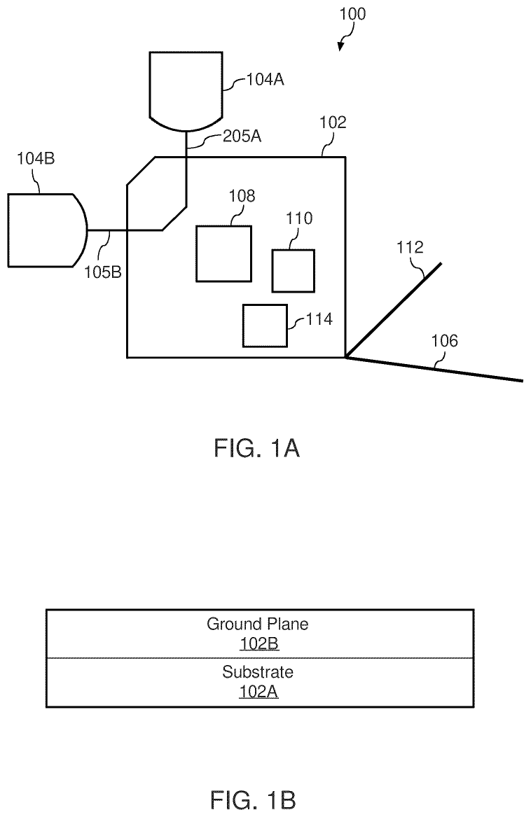

FIG. 1A illustrates a block diagram of an example switchable antenna assembly 100 according to some embodiments of the present disclosure. The switchable antenna assembly 100 includes a substrate/ground plane 102. Specifically, as illustrated in FIG. 1B, the switchable antenna assembly includes a planar substrate 102A, and a ground plane 102B disposed on the substrate 102A. In some embodiments, the switchable antenna assembly 100 is configured for 6E WiFi signaling/communications.

Returning to FIG. 1A, the switchable antenna assembly 100 includes a first planar antenna element 104A configured to produce a first radiation pattern, and a second planar antenna element 104B configured to produce a second radiation pattern. The first planar antenna element 104A and the second planar antenna element 104B can be co-planer with the ground plane. In some embodiments, the first radiation pattern can be associated with a first polarization, and the second radiation pattern can be associated with a second polarization different than the first polarization. The first antenna element 104A can extend from the ground plane 102 via a transmission line 105A in a first direction, and the second antenna element 104B can extend from the ground plane 102 via a transmission line 105B in a second direction. In some embodiments, the first planar antenna element 104A and the second planar antenna element 104B are configured to communicate a signal having a frequency between about 5 Ghz and about 7.2 Ghz.

Further, the switchable antenna assembly 100 includes a feed 106, and a single pole—two-throw switching element 108. The single pole—two-throw switching element 108 is configured to selectively couple one of the first transmission line 105A or the second transmission line 105B to the feed 106 (e.g., to provide radiofrequency signals to the respective planar antenna element 104). For example, the single pole—two-throw switching element 108 may selectively couple the first and second planar antenna elements in a manner such as to provide omni-directional WiFi signaling. Although it is not explicitly illustrated, it should be noted that in some embodiments the single pole—two-throw switching element 108 can be positioned atop the first and second transmission lines 105.

In some embodiments, the switchable antenna assembly 100 can include a control circuit 110. The control circuit 110 can control the single pole—two-throw switching element 108. In some embodiments, the switchable antenna assembly 100 can include a data over coaxial circuit 112 (e.g., a single coaxial circuit). The data over coaxial circuit 112 can carry a control signal, and the control circuit 110 can control the single pole—two-throw switching element based on the control signal.

In some embodiments, the control signal carried by the data over coaxial circuit 112 is modulated onto a radio frequency signal that is carried concurrently with the control signal over the data over coaxial circuit. For example, in some embodiments, the switchable antenna assembly 100 may include a radio frequency circuit 114 that can modulate or demodulate the control signal from the radio frequency signal carried by the data over coaxial circuit 112 to control the switching element 108.

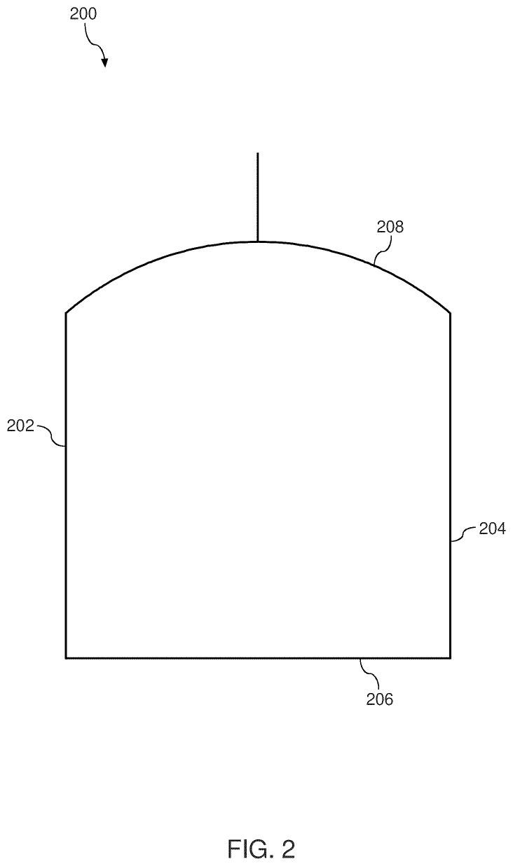

FIG. 2 depicts an example planar antenna element 104 of FIG. 1A according to some embodiments of the present disclosure. Specifically, the planar antenna element 104 can define a shape 200. The shape 200 can include a straight first edge 202. The shape 200 can include a straight second edge 204 that is parallel to the straight first edge 202. The straight second edge 204 can have the same dimensions as the straight first edge 202. The shape 200 can include a straight third edge 206 that is perpendicular to the straight first edge 202 and the straight second edge 204. A first endpoint of the straight third edge 204 can contact a first endpoint of the straight first edge 202 and a second endpoint of the straight third edge 204 can contact a first endpoint of the straight second edge 204.

Finally, the shape 200 can include a curved fourth edge 208. The curved fourth edge 208 can be parallel to the straight third edge 206, and can curve away from the straight third edge 206. A first endpoint of the curved fourth edge 208 can contact a second endpoint of the straight first edge 202, and a second endpoint of the curved fourth edge 208 can contact a second endpoint of the second straight edge 204.

In such fashion, the straight first edge 202, the straight second edge 204, the straight third edge 206, and the fourth curved edge 208 can collectively form a closed shape 200 defined by the planar antenna element 104 of FIG. 1A.

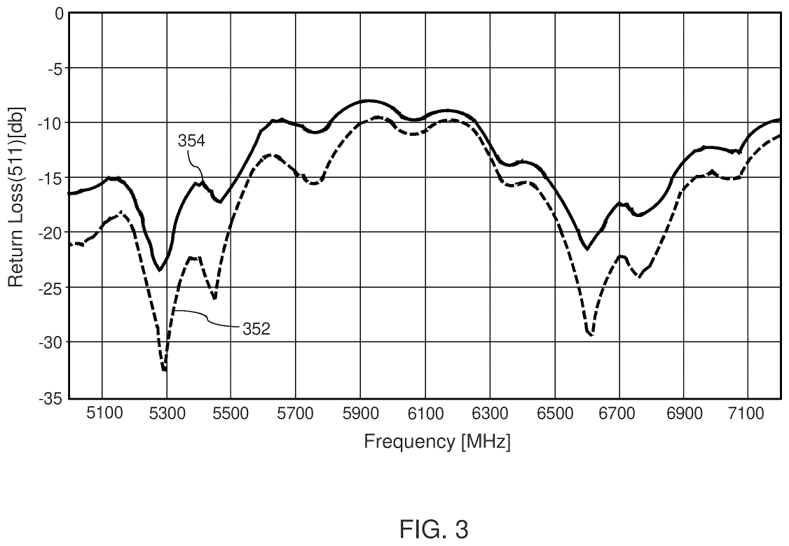

FIG. 3 illustrates a return loss plot associated with some example antenna assemblies according to some embodiments of the present disclosure.

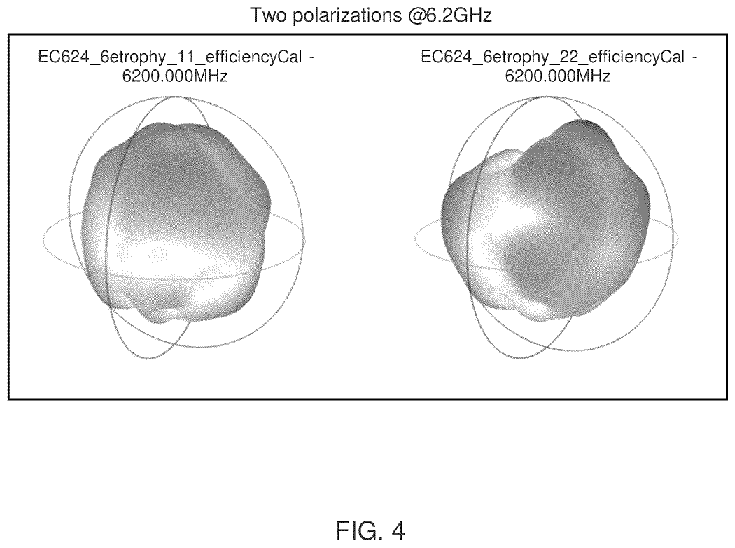

FIG. 4 illustrates a radiation pattern of one of the antenna planar antenna elements of FIG. 1 according to some embodiments of the present disclosure.

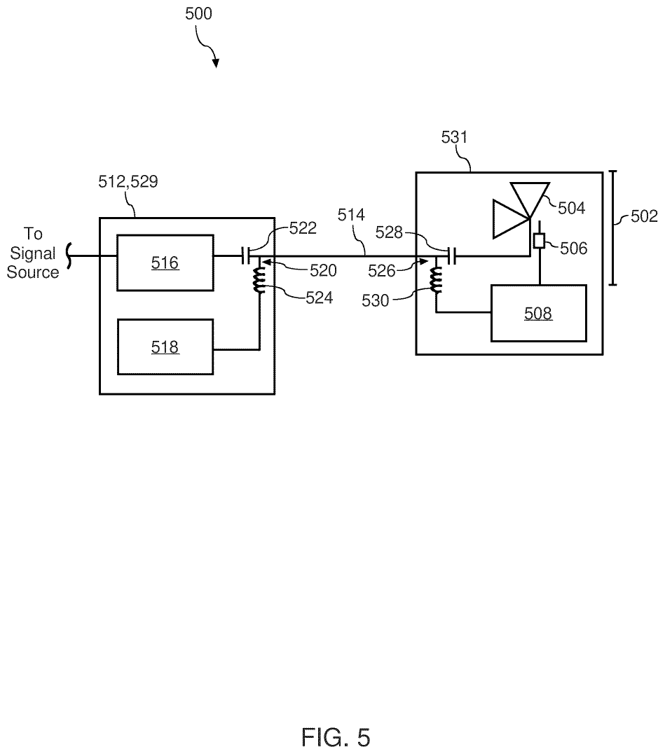

FIG. 5 illustrates a schematic diagram of an embodiment of an antenna system 500 in accordance with example aspects of the present disclosure. The antenna system 500 may include a switching antenna assembly 502. The switching antenna assembly 502 may include two switching patch antenna elements 504 and a single pole two-throw switching element 506 configured to selectively couple one of the first transmission line or the second transmission line to a feed. The switching antenna assembly 502 may be operable in a plurality of different modes, and each mode may be associated with a different radiation pattern.

A control circuit, such as tuning circuit 508 (e.g., a control circuit), may be configured to control an electrical characteristic associated with the single pole two-throw switching element 506 to operate the switching antenna assembly 502 in the plurality of different modes. The tuning circuit 508 may be configured demodulate a control signal from a transmit signal and control the electrical characteristic of the single pole two-throw switching element 506 based on control instructions associated with the control signal.

The single pole two-throw switching element 506 may be coupled with the planar antenna elements 504, and the tuning circuit 508 may be configured to control the single pole two-throw switching element 506 to alter the electrical connectivity of the planar antenna elements 504 with a feed.

A radio frequency circuit 512 may be configured to transmit an RF signal to the planar antenna elements 504 of the switching antenna assembly 502. For example, a transmission line 514 may couple the radio frequency circuit 510 to the switching antenna assembly 502. In some embodiments, the transmission line 514 may be a single coaxial cable configured to provide data over coaxial functionality. The radio frequency circuit 512 may be configured to amplify or otherwise generate the RF signal, which is transmitted through the transmission line 514 (as a component of the transmit signal) to the active patch antenna element 504 of the modal antenna assembly 502.

In some embodiments, the radio frequency circuit 512 may include a front end module 516 and/or a control instruction circuit 518. The front end module 516 may be configured to generate and/or amplify the RF signal that is transmitted to the active patch antenna element 504. The control instruction circuit 518 may be configured to modulate a control signal onto the RF signal using amplitude-shift keying modulation to generate the transmit signal.

The transmission lines 514 may be coupled with various components (e.g., using Bias Tee circuits) that are configured to aid in the combination and/or separation of signals occupying various frequency bands. For example, a first Bias Tee circuit 520 may couple the front end module 516 and the control instruction circuit 518 with the transmission lines 514. The first Bias Tee circuit 520 may include a capacitor 522 coupling the transmission lines 514 with front end module 516 and an inductor 524 coupling the control instruction unit 518 with the transmission lines 514. A second Bias Tee circuit 526 may couple the planar antenna elements 504 and the tuning circuit 508 with the transmission lines 514. The second Bias Tee circuit 526 may include a capacitor 528 coupling the transmission lines 514 with the planar antenna elements 504 and an inductor 530 coupling the transmission line 514s with the tuning circuit 508.

The front end module 516 may transmit the RF signal through the capacitor 522 of the first Bias Tee circuit 520. The control circuit 518 may modulate the control signal onto the RF signal through the inductor 524 of the first Bias Tee circuit 120 to generate the control signal in the transmission line 514. The tuning circuit 508 may de-modulate the control signal from the transmit signal via the inductor 530 of the second Bias Tee circuit 528. The RF signal component of the transmit signal may be transmitted to the planar antenna elements 504 of the modal antenna 502 via the capacitor 528 of the second Bias Tee circuit 528.

In some embodiments, the antenna system 500 may include a first circuit board 529 and a second circuit board 531 that is physically separate from the first circuit board 529. The radio frequency circuit 512 may be disposed on the first circuit board 529, and at least one of the tuning circuit 508 or switching antenna assembly 502 may be disposed on the second circuit board 531. This may allow radio frequency circuit 512 to be physically separated from the tuning circuit and/or modal antenna assembly 502 without employing multiple transmission lines or adversely affecting the operation of the antenna system 500.

In some embodiments, the RF signal may be defined within a first frequency band, and the control signal may be defined within a second frequency band that is distinct from the first frequency band. For example, the first frequency band may range from about 500 MHz to about 50 GHz, in some embodiments from about 1 GHz to about 25 GHz, in some embodiments from about 2 GHz to about 7 GHz, e.g., about 5 GHz. The second frequency band may range from about 10 MHz to about 1 GHz, in some embodiments from about 20 MHz to about 800 MHz, in some embodiments from about 30 MHz to about 500 MHz, in some embodiments from about 50 MHz to about 250 MHz, e.g., about 100 MHz. More generally, the frequency bands defined by the RF signal may be millimeter wave frequency bands.

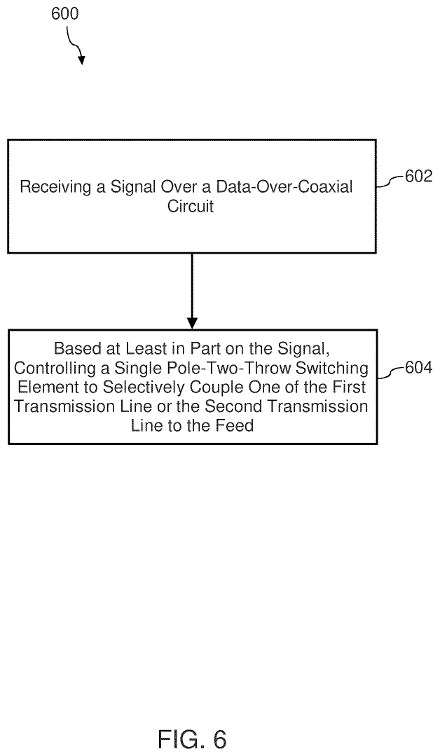

FIG. 6 is a flowchart illustrating an example method 600 for omni-directional 6E Wifi signaling according to some embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, the switchable antenna assembly receives a signal over a data-over-coaxial circuit. The switchable antenna assembly can include a first planar antenna element connected to a feed via a first transmission line and an identically shaped second planar antenna element connected to the feed via a second transmission line.

At 604, the switchable antenna assembly can, based at least in part on the signal, control a single pole—two-throw switching element to selectively couple one of the first transmission line or the second transmission line to the feed.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A switchable antenna assembly, the switchable antenna assembly comprising:
a substrate;
a ground plane disposed on the substrate;
a feed;
a first planar antenna element extending from the ground plane in a first direction, wherein the first planar antenna element is coupled to the feed by a first transmission line, wherein the first planar antenna element is configured to produce a first radiation pattern;
a second planar antenna element extending from the ground plane in a second direction orthogonal to the first direction of first planar antenna element, wherein the second planar antenna element is configured to produce a second radiation pattern; and
a single pole—two-throw switching element configured to selectively couple one of the first transmission line or the second transmission line to the feed.

2. The switchable antenna assembly of claim 1, wherein the first planar antenna element and the second planar antenna element are configured to produce a signal between about GHz and about 7.2 GHz.

3. The switchable antenna assembly of claim 1, wherein the two-throw switching element is controlled via a control circuit.

4. The switchable antenna assembly of claim 3, wherein the switchable antenna assembly further comprises a data over coaxial circuit, and wherein the two-throw switching element is controlled via the control circuit based at least in part on a control signal carried via a data over coaxial circuit.

5. The switchable antenna assembly of claim 4, wherein the control signal is modulated onto a radio frequency signal carried concurrently with the control signal via the data over coaxial circuit.

6. The switchable antenna assembly of claim 5, wherein the switchable antenna assembly further comprises a radio frequency circuit, and wherein the control signal is demodulated from the radio frequency signal using the radio frequency circuit.

7. The switchable antenna assembly of claim 5, wherein the radio frequency signal is defined within a first frequency band, and the control signal is defined within a second frequency band that is distinct from the first frequency band.

8. The switchable antenna assembly of claim 1, wherein the two-throw switching element is positioned atop the first and second transmission lines.

9. The switchable antenna assembly of claim 1, wherein the first radiation pattern is associated with a first polarization, the second radiation pattern is associated with a second polarization, the first polarization being different from the second polarization.

10. The switchable antenna assembly of claim 1, wherein the first planar antenna element defines a first shape, and wherein the second planar antenna element defines a second shape identical to the first shape.

11. The switchable antenna assembly of claim 10, wherein the first shape of the first planar antenna element comprises:
a straight first edge;
a straight second edge parallel to the first edge;
a straight third edge, wherein a first endpoint of the third edge contacts a first endpoint of the first edge and a second endpoint of the third edge contacts a first endpoint of the second edge; and
a curved fourth edge, wherein a first endpoint of the fourth edge contacts a second endpoint of the first edge and a second endpoint of the fourth edge contacts a second endpoint of the second edge.

12. The switchable antenna assembly of claim 1, wherein the switchable antenna assembly is configured for 6e Wifi signaling.

13. A method for signaling via a switchable antenna assembly, comprising:
receiving, by a switchable antenna assembly, a signal over a data-over-coaxial circuit, wherein the switchable antenna assembly comprises a first planar antenna element connected to a feed via a first transmission line and an identically shaped second planar antenna element connected to the feed via a second transmission line;
based at least in part on the signal, controlling, by the switchable antenna assembly, a single pole—two-throw switching element to selectively couple one of the first transmission line or the second transmission line to the feed.

14. A switchable antenna assembly, the switchable antenna assembly comprising:
a substrate;
a ground plane disposed on the substrate;
a feed;
a first planar antenna element extending from the substrate in a first direction, wherein the first planar antenna element defines a first shape comprising:
a straight first edge;
a straight second edge parallel to the first edge;
a straight third edge, wherein a first endpoint of the third edge contacts a first endpoint of the first edge and a second endpoint of the third edge contacts a first endpoint of the second edge; and
a curved fourth edge, wherein a first endpoint of the fourth edge contacts a second endpoint of the first edge and a second endpoint of the fourth edge contacts a second endpoint of the second edge; and
a second planar antenna element extending from the substrate in a second direction orthogonal to the first direction, wherein the second planar antenna element defines a second shape identical to the first shape.
